(19) United States
(12) Patent Application Publication
(10) Pub. No.: US 2006/0251102 A1
(43) Pub. Date: Nov. 9, 2006

(54) Method and apparatus for dynamically adjusting deferred transmission level in a wireless communication system

(75) Inventor: Arty Chandra, Manhasset Hills, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/209,078

(22) Filed: Aug. 22, 2005

Related U.S. Application Data
(60) Provisional application No. 60/678,645, filed on May 6, 2005.

(51) Int. Cl. H04L 12/413; H04J 3/02

(52) U.S. Cl. 370/445; 370/462

(57) ABSTRACT

The present invention is a method and apparatus for dynamically adjusting deferred transmission level in a wireless communication system implementing carrier sense multiple access/collision avoidance (CSMA/CA) mechanism. An access point (AP) and a station (STA) measure signal strength from an associated STA and AP and neighboring APs and adjust the deferred transmission level in accordance with the measurement results. If the energy level of the signals transmitted from the associated AP or STA is higher than energy level of signals transmitted from neighboring APs by a predetermined threshold, the AP and STA increase the deferred transmission level. Otherwise, the AP and STA may maintain the current deferred transmission level or decrease the deferred transmission level.

### CROSS REFERENCE TO RELATED APPLICATION

This application claims the benefit of U.S. provisional application No. 60/678,645, filed May 6, 2005, which is incorporated by reference as if fully set forth.

### FIELD OF INVENTION

The present invention is related to wireless communication systems. More particularly, the present invention is a method and apparatus for dynamically adjusting a deferred transmission level in a wireless communication system implementing a carrier sense multiple access/collision avoidance (CSMA/CA) mechanism.

### BACKGROUND

In wireless local area networks (WLANs) implementing a CSMA/CA mechanism, access points (APs) and stations (STAs) monitor the transmission medium before transmitting data. If it is detected that the medium is busy, APs and STAs defer transmission. The APs and STAs detect that the medium is busy if they receive a signal level greater than a certain threshold, which is called the “deferred transmission level.” As more APs are deployed, transmissions from APs will increasingly interfere with each other, hence, causing deferred transmissions from on-going sessions in other co-channel APs.

It is important that the deferred transmission level be set properly. If it is set too low, the APs and STAs may unnecessarily defer transmission to other APs and STAs. If it is set too high, many collisions may occur since the APs and STAs would transmit data even though the medium is already busy.

Therefore, it is desirable to find a scheme for properly setting the deferred transmission level in STAs and APs.

### SUMMARY

The present invention is a method and apparatus for dynamically adjusting a deferred transmission level in a wireless communication system implementing a CSMA/CA mechanism. An AP and a STA measure the signal strength from an associated STA and AP and neighboring APs, and adjust the deferred transmission level in accordance with the measurement results. If the energy level of the signals transmitted from the associated AP or STA is higher than energy level of signals transmitted from neighboring APs by a predetermined threshold, the AP and STA increase the deferred transmission level. Otherwise, the AP and STA may maintain the current deferred transmission level or decrease the deferred transmission level.

### BRIEF DESCRIPTION OF THE DRAWINGS

FIG. 1 is a block diagram of an infrastructure mode network implementing a method for dynamically adjusting the deferred transmission level in accordance with the present invention.

FIG. 2 is a block diagram of an ad hoc network implementing a method for dynamically adjusting the deferred transmission level in accordance with the present invention.

FIG. 3 is a flow diagram of a process for dynamically adjusting the deferred transmission level in accordance with the present invention.

FIG. 4 is a block diagram of an apparatus for dynamically adjusting the deferred transmission level in accordance with the present invention.

FIG. 5 is a diagram of a medium access control (MAC) frame format.

### DETAILED DESCRIPTION OF THE PREFERRED EMBODIMENTS

Hereafter, the terminology “STA” includes but is not limited to a user equipment, a wireless transmit/receive unit (WTRU), a fixed or mobile subscriber unit, a pager, or any other type of device capable of operating in a wireless environment. When referred to hereafter, the terminology “AP” includes but is not limited to a Node-B, a base station, a site controller or any other type of interfacing device in a wireless environment.

The features of the present invention may be incorporated into an integrated circuit (IC) or be configured in a circuit comprising a multitude of interconnecting components.

The present invention is applicable to any wireless communication system implementing a CSMA/CA mechanism such as an IEEE 802.11x based WLAN. The WLAN may be an infrastructure network, an ad hoc network or a mesh network.

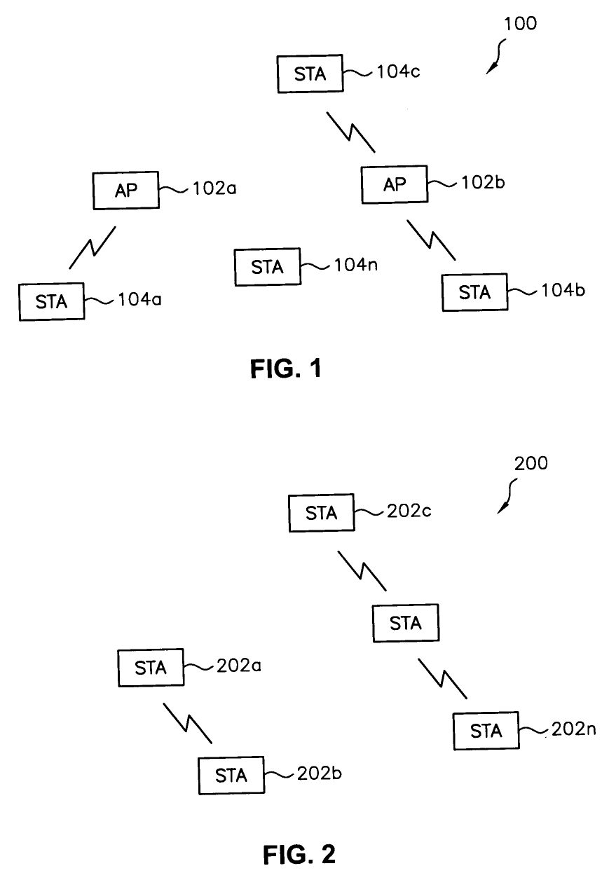

FIG. 1 is a block diagram of an infrastructure mode WLAN 100 implementing a method for dynamically adjusting the deferred transmission level in accordance with the present invention. The WLAN 100 comprises a plurality of APs 102a, 102b and STAs 104a-104n. For example, STA 104a is currently associated with AP 102a. APs 102a, 102b and STAs 104a-104n implement a CSMA/CA mechanism in order to access the medium.

FIG. 4 is a block diagram of an apparatus 400 for dynamically adjusting the deferred transmission level in accordance with the present invention. The apparatus 400 comprises a measurement unit 402 and a controller 404. The apparatus 400 may be included in any communication entity, such as an AP or a STA. The measurement unit 402, periodically or non-periodically, measures the level of signals in the medium being monitored by the controller 404. The controller 404 then sets a deferred transmission level based on the measurement results, which will be described in detail hereinafter.

A measurement unit 402 within each AP 102a, 102b or STA 104a-104n monitors the medium and each associated controller 404 within each AP 102a, 102b or STA 104a-104n compares the detected energy level to a deferred transmission level before transmitting data. In accordance with the present invention, the deferred transmission level is dynamically adjusted based on the measured signal strength from the associated AP and/or STAs and/or interference level.

The operator of the WLAN 100 can base the deferred transmission levels of the APs 102a-102b and STAs 104a-104n on the signal strength measurement, the interference level or any other type of factor, such as the levels set by the operator of neighboring APs.

For example, AP 102a measures the energy level of signals transmitted from the associated STA 104a and neighboring APs 102b, periodically or non-periodically. The STA 104a also measures the energy level of signals transmitted from the associated AP 102a and neighboring APs 102b, periodically or non-periodically. The AP 102a and STA 104a then individually adjust their deferred transmission level based on the measurement results. If the energy level of the signals transmitted from the associated AP 102a and STA 104a is higher than energy level of signals transmitted from neighboring APs 102b by a predetermined threshold, the AP 102a and STA 104a increase the deferred transmission level. If the energy level of the signals transmitted from the associated AP 102a and STA 104a is not higher than energy level of signals transmitted from neighboring APs 102b by a predetermined threshold, the AP 102a and STA 104a may maintain the current deferred transmission level, or may decrease the deferred transmission level.

Alternatively, the STA 104a may report the measurement results to the associated AP 102a instead of adjusting the deferred transmission level by itself. In this scheme, after measuring the signal strength from the associated AP 102a and neighboring APs 102b, the STA 104a reports the measurement results to the associated AP 102a. The associated AP 102a then adjusts the deferred transmission level and sends the deferred transmission level information to the STA 104a, so that it may, in turn, adjust its own transmission level.

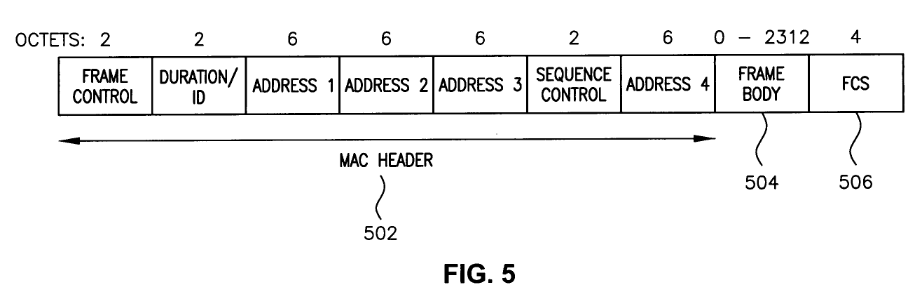

The deferred transmission level information may be sent in any frame, such as a beacon frame, a clear-to-send (CTS) frame, a request-to-send (RTS) frame, a data frame, an acknowledgement (ACK) frame, or in an individual control frame specifically designated for this purpose. For example, FIG. 5 shows a MAC frame format 500. The MAC frame 500 includes a MAC header 502, a frame body 504 and a frame check sequence (FCS) field 506. The deferred transmission level information may be included in any of the aforementioned fields.

A beacon frame is a type of management frame which enables STAs to establish and maintain communications in an orderly fashion. The beacon frame includes a header, a frame body and a cyclic redundancy check (CRC) field. The beacon frame body includes, among other things, information regarding a beacon interval, a timestamp, a service set identifier (SSID), supported rates, parameter sets, capability and traffic indication map (TIM). The deferred transmission level information may be included as one of the information elements in the beacon frame.

RTS and CTS frames are optionally transmitted frames to reduce frame collisions when hidden STAs have associations with the same AP. An STA and an AP exchange an RTS frame and a CTS frame in a two-way handshake method before sending a data frame. The deferred transmission level information may be included in the RTS or CTS frame.

An ACK frame is sent after successful receipt of a data frame as a part of an error checking process. The deferred transmission level information may be included in the ACK frame or the data frame.

It should be noted that the foregoing list of frames are provided as an example and any other type of frames may be utilized for transmission of the deferred transmission level information.

FIG. 2 is a block diagram of an ad hoc network 200 implementing the method for dynamically adjusting the deferred transmission level in accordance with the present invention. The ad hoc network 200 comprises a plurality of STAs 202a-202n directly communicating each other. Each STA 202a-202n measures the signal strength from a connected STA and other neighboring STAs. For example, assume that STA 202a is currently connected to STA 202b. If the energy level of signals transmitted from the connected STA 202b is higher than energy level of signals transmitted from neighboring STAs 202c-202n by a predetermined threshold, the STA 202a increases the deferred transmission level. If the energy level of the signals transmitted from the connected STA 202b is not higher than energy level of signals transmitted from neighboring STAs 202c-202n by a predetermined threshold, the STA 202a may maintain the current deferred transmission level or may decrease the deferred transmission level. Although not shown herein, the present invention may also be implemented in a mesh network or any other type of wireless or wired network using a CSMA/CA mechanism.

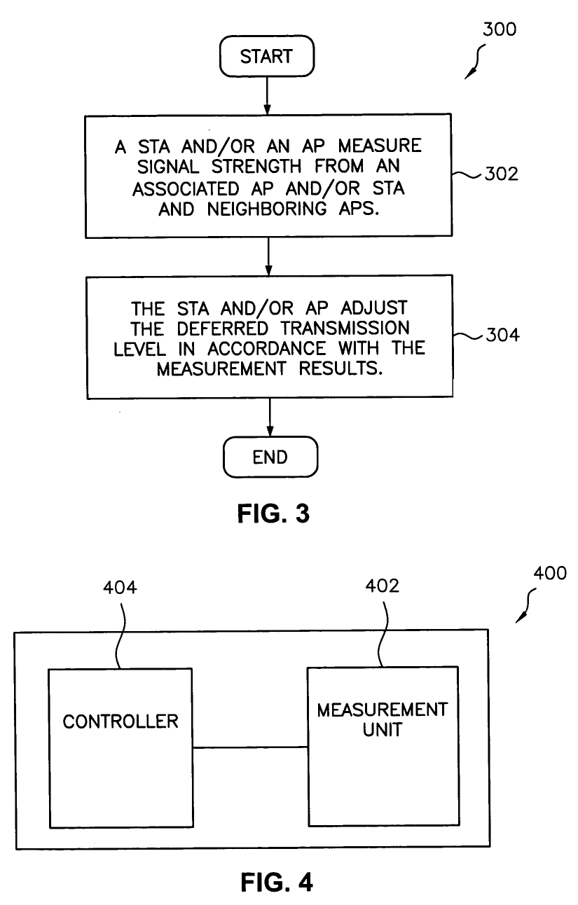

FIG. 3 is a flow diagram of a process 300 for dynamically adjusting the deferred transmission level in accordance with the present invention. An STA and/or an AP measure the signal strength or another parameter from an associated AP and/or STA and neighboring APs; either periodically or non-periodically (step 302). The STA and/or AP then adjust the deferred transmission level in accordance with the measurement results (step 304).

Although the features and elements of the present invention are described in the preferred embodiments in particular combinations, each feature or element can be used alone without the other features and elements of the preferred embodiments or in various combinations with or without other features and elements of the present invention.

What is claimed is:

1. In a wireless communication system comprising a plurality of communication entities, each communication entity monitoring a communication medium and transmitting data only if the signal level detected in the medium is lower than a deferred transmission level, a method for dynamically adjusting the deferred transmission level, comprising:
measuring the signal strength from an associated communication entity and at least one neighboring communication entity; and
adjusting the deferred transmission level based upon the measurement results.

2. The method of claim 1 wherein each communication entity dynamically determines its own deferred transmission level.

3. The method of claim 1 wherein the communication entities send measurement results to a predetermined communication entity, the predetermined communication entity determines the deferred transmission level, and the predetermined communication entity sends the deferred transmission level information to other communication entities.

4. The method of claim 4 wherein the deferred transmission level information is transmitted in a beacon frame.

5. The method of claim 4 wherein the deferred transmission level information is transmitted in one of a clear-to-send frame, a request-to-send frame, a data frame and an acknowledgement (ACK) frame.

6. The method of claim 4 wherein the deferred transmission level information is transmitted in an individual control frame.

7. The method of claim 1 wherein the wireless communication system is one of an ad hoc network, an infrastructure network and a mesh network.

8. In a wireless communication system comprising a plurality of communication entities, each communication entity monitoring an energy level of a communication medium and transmitting data only if the energy level detected in the medium is lower than a deferred transmission level, a communication entity for dynamically adjusting the deferred transmission level, comprising:
a measurement unit for measuring signal strength from an associated communication entity and at least one neighboring communication entity; and
a controller for adjusting the deferred transmission level based upon the measurement results.

9. The communication entity of claim 8 wherein the wireless communication system is one of an ad hoc network, an infrastructure network and a mesh network.

10. In a wireless communication system comprising a plurality of access points (APs) and stations (STAs), the APs and the STAs monitoring an energy level of a communication medium and transmitting data only if the energy level detected in the medium is lower than a deferred transmission level, a STA for dynamically adjusting the deferred transmission level, comprising:
a measurement unit for measuring signal strength from an associated AP and neighboring APs; and
a controller for adjusting the deferred transmission level in accordance with the measurement results.

11. The STA of claim 10 wherein the STA determines its own deferred transmission level.

12. The STA of claim 10 wherein the STA sends the measurement results to the associated AP, whereby the associated AP determines the deferred transmission level and sends the deferred transmission level information to the STA.

13. The STA of claim 12 wherein the deferred transmission level information is transmitted in a beacon frame.

14. The STA of claim 12 wherein the deferred transmission level information is transmitted in one of a clear-to-send frame, a request-to-send frame, a data frame, and an acknowledgement (ACK) frame.

15. The STA of claim 12 wherein the deferred transmission level information is transmitted in an individual control frame.

16. In a wireless communication system comprising a plurality of stations (STAs), the STAs monitoring a communication medium before transmitting data and transmitting data only if an energy level detected in the medium is lower than a deferred transmission level, a STA for dynamically adjusting the deferred transmission level, comprising:
a measurement unit for measuring signal strength from a connected STA and neighboring STAs; and
a controller for adjusting the deferred transmission level based upon the measurement results.

17. In a wireless communication system comprising a plurality of access points (APs) and stations (STAs), the APs and the STAs monitoring a communication medium and transmitting data only if an energy level detected in the medium is lower than a deferred transmission level, an AP for dynamically adjusting the deferred transmission level, comprising:
a measurement unit for measuring signal strength from an associated STA and neighboring APs; and
a controller for adjusting the deferred transmission level in accordance with the measurement results.

18. The AP of claim 17 further comprising a means for determining deferred transmission level of the associated STA.

19. The AP of claim 17 wherein the deferred transmission level of STAs is set via signaling through the AP.

20. The AP of claim 19 wherein the deferred transmission level is transmitted in a beacon frame from the AP.

21. The AP of claim 19 wherein the deferred transmission level is transmitted in one of a clear-to-send frame, a request-to-send frame, a data frame, and an acknowledgement (ACK) frame.

22. The AP of claim 19 wherein the deferred transmission level is transmitted in an individual control frame.
